(19) United States
(12) Patent Application Publication
(10) Pub. No.: US 2025/0274208 A1
(43) Pub. Date: Aug. 28, 2025

(54) AUTOMATIC SELECTION OF AUDIO BROADCAST BASED ON DIRECTION

(71) Applicant: Motorola Mobility LLC, Chicago, IL (US)

(72) Inventors: Vineet Vivekanand Angadi, Dharwad (IN); Vijayakumar Garudanagiri Nagabhushana, Bangalore (IN); Ashwin Kumar Manmohan Pathmudi, Pune (IN)

(73) Assignee: Motorola Mobility LLC, Chicago, IL (US)

(21) Appl. No.: 18/585,534

(22) Filed: Feb. 23, 2024

(51) Int. Cl. H04H 20/95; H04H 20/71

(52) U.S. Cl. CPC H04H 20/95; H04H 20/71

(57) ABSTRACT

In aspects of automatic selection of audio broadcast based on direction, a media playback manager detects an available Bluetooth Low Energy (BLE) audio broadcast from a media device. Based on a location of a tag associated with the media device, the media playback manger determines a position of a wireless device relative to the media device. The media playback manager then receives the BLE audio broadcast at the wireless device based on the position of the wireless device relative to the location of the tag that is associated with the media device.

### BACKGROUND

Ultra-wideband (UWB) is a radio technology that can be utilized for secure, spatial location applications using very low energy for short-range, high-bandwidth communications. The UWB technology supports accurate relative position tracking, and provides for applications using relative distance between entities. Notably, UWB utilizes two-way ranging between devices and provides for highly precise positioning for time-of-flight (ToF) and angle-of-arrival (AoA) measurements.

### BRIEF DESCRIPTION OF THE DRAWINGS

Implementations of the techniques for automatic selection of audio broadcast based on direction are described with reference to the following Figures. The same numbers may be used throughout to reference like features and components shown in the Figures:

FIG. 1 illustrates example devices and features for automatic selection of audio broadcast based on direction in accordance with one or more implementations as described herein.

FIG. 2 illustrates an example environment of automatic selection of audio broadcast based on direction in accordance with one or more implementations as described herein.

FIG. 3 illustrates an example of automatic selection of audio broadcast based on direction and a broadcast queue in accordance with one or more implementations as described herein.

FIGS. 4 and 5 illustrate examples of automatic selection of audio broadcast based on direction in accordance with one or more implementations as described herein.

FIG. 6 illustrates an example method for automatic selection of audio broadcast based on direction in accordance with one or more implementations of the techniques described herein.

FIG. 7 illustrates an example method for of generating a queue of broadcast events for automatic selection of audio broadcast based on direction as described herein.

FIG. 8 illustrates various components of an example device that can be used to implement the techniques for automatic selection of audio broadcast based on direction as described herein.

### DETAILED DESCRIPTION

Implementations of techniques for automatic selection of audio broadcast based on direction are described, and provide techniques that can be implemented by any type of wireless devices, such as smart devices, mobile devices (e.g., cellular phones, tablet devices, smartphones), consumer electronics, media devices, smart home automation devices, headphones, earphones, and the like.

Bluetooth Low Energy (BLE) is a wireless communication technology designed for short-range communication between devices. BLE is a power-efficient version of Bluetooth technology and can be used in various situations involving low power consumption. Some conventional technologies are capable of transmitting a BLE audio broadcast from a BLE transmitter to a receiving device, such as a wireless device. For example, a media device may be a display screen in a public area that presents visual media content and is equipped with a BLE transmitter. Instead of outputting audio content that corresponds to the visual content at speakers connected to the display screen, the BLE transmitter transmits a BLE audio broadcast, including the audio content, to wireless devices within range of the BLE transmitter. Users within range of the BLE transmitter can then listen to the received BLE audio broadcast via their wireless device, such as a mobile phone, headphones, or earphones.

These conventional BLE audio playback technologies have limitations, however. For example, a user may be within range of a BLE transmitter but is not actively looking at the display screen and does not desire to listen to the BLE audio broadcast. The user experience may then be less than ideal when the conventional BLE audio playback technology causes automatic playback of the BLE audio broadcast. Conversely, a user may be within range of the BLE transmitter and is actively looking at the display screen, but cannot listen to the BLE audio, which does not play automatically and must be manually initiated by the user. In other situations, an environment may include multiple BLE transmitters that transmit multiple available BLE audio broadcasts, and a user selects a particular BLE audio broadcast from a list of available broadcasts displayed on the wireless device. However, some of the available BLE audio broadcasts may include more important information than others, and the user may miss important information, such as an emergency broadcast, if the user selects the wrong broadcast from the list.

Techniques and systems are described for automatic selection of audio broadcast based on direction that overcome these limitations. A media playback system in this example includes UWB tags associated with respective media devices, and the UWB tags are capable of transmitting different BLE audio broadcasts in an environment via BLE transmitters. The system also includes a media playback manager, such as may be implemented by a wireless device or other computing device in one or more implementations, and a user may carry the wireless device in the environment. The wireless device is configured with a UWB positioning system, such as a UWB radio. The media playback manager can determine the location of each of the UWB-tagged media devices in the environment based on a location of the UWB tags relative to the position of the UWB radio of the positioning system in the wireless device. For example, the media playback manager utilizes UWB ranging data, such as time-of-flight (ToF), angle-of-arrival (AoA), and/or time-difference-of-arrival (TDoA) to determine UWB tag and UWB radio locations in the environment. In some examples, the AoA may be determined based on directionally-aware protocols other than UWB, including, but not limited to Bluetooth (e.g., versions 5.1 and above), Wi-Fi standards such as 802.11ac and 802.11ax (e.g., Wi-Fi 5 and Wi-Fi 6), and cellular network standards such as 5G New Radio (NR). The media playback manager may be configured to automatically receive and facilitate playback of a BLE audio broadcast at the wireless device based on predetermined criteria, such as when the wireless device is within a threshold distance of the media device. In this situation, the media playback manager leverages the UWB ranging data to determine whether the criteria for receival and playback of the BLE audio broadcast is met.

To determine which of multiple BLE audio broadcasts to receive for playback at the wireless device, the media playback manager can determine a location of each of the media devices relative to the position of the wireless device. For example, by utilizing the UWB ranging data and AoA techniques, as well as sensors on a wireless device and/or a captured image of the environment, the media playback manager can determine the direction that the user's wireless device is facing, and the media device that the user's orientation is likely facing toward.

Other sensors of the wireless device can also indicate a particular orientation of the wireless device to the user, such as when the user carries the wireless device in a pocket and the device display is facing the body of the user, which would indicate that the UWB antenna array is pointed in the direction the user is moving. Alternatively, the device display may be facing outwards away from the body of the user, which would indicate that the UWB antenna array is pointed in an opposite direction to the vector of travel of the user. In other implementations utilizing sensors of the wireless device, the orientation of the user in the environment may be determinable by the media playback manager based on user face detection, eye gaze detection with a camera of the device, and/or with other types of sensors that sense proximity of the user. The media playback manager can then determine a particular BLE audio broadcast of multiple BLE audio broadcasts to receive for playback at the wireless device based on the user orientation and/or where the user is looking.

The media playback manager can also generate a broadcast queue, which is a determined order for playback of available BLE audio broadcasts. The broadcast queue can be determined based on any predetermined criteria, such as relative importance of the BLE audio broadcasts in this example. To determine the relative importance of a BLE audio broadcast, the media playback manager extracts metadata from the BLE audio broadcast. For example, metadata corresponding to the BLE audio broadcast can indicate that the BLE audio broadcast is an emergency broadcast and therefore corresponds to a higher ranking in the broadcast queue than another BLE audio broadcast featuring a weather report. The media playback manager generates the broadcast queue, specifying the order for automatic playback of the BLE audio broadcasts.

Automatic selection of audio broadcast based on direction overcomes the limitations of the conventional BLE audio playback technologies. For example, determining whether a user is actively looking at a display screen that is transmitting a BLE audio broadcast and subsequently determining whether to receive the BLE audio broadcast avoids unwanted automatic transmission of the BLE audio broadcast if the user is not looking at the display screen. This also avoids unnecessary manual initiation of the BLE audio broadcast if the user is looking at the display screen. In situations involving multiple BLE transmitters, automatically generating a broadcast queue based on broadcast importance avoids manual toggling between multiple BLE audio broadcasts.

While features and concepts of the described techniques for automatic selection of audio broadcast based on direction can be implemented in any number of different devices, systems, environments, and/or configurations, implementations of the techniques for automatic selection of audio broadcast based on direction are described in the context of the following example devices, systems, and methods.

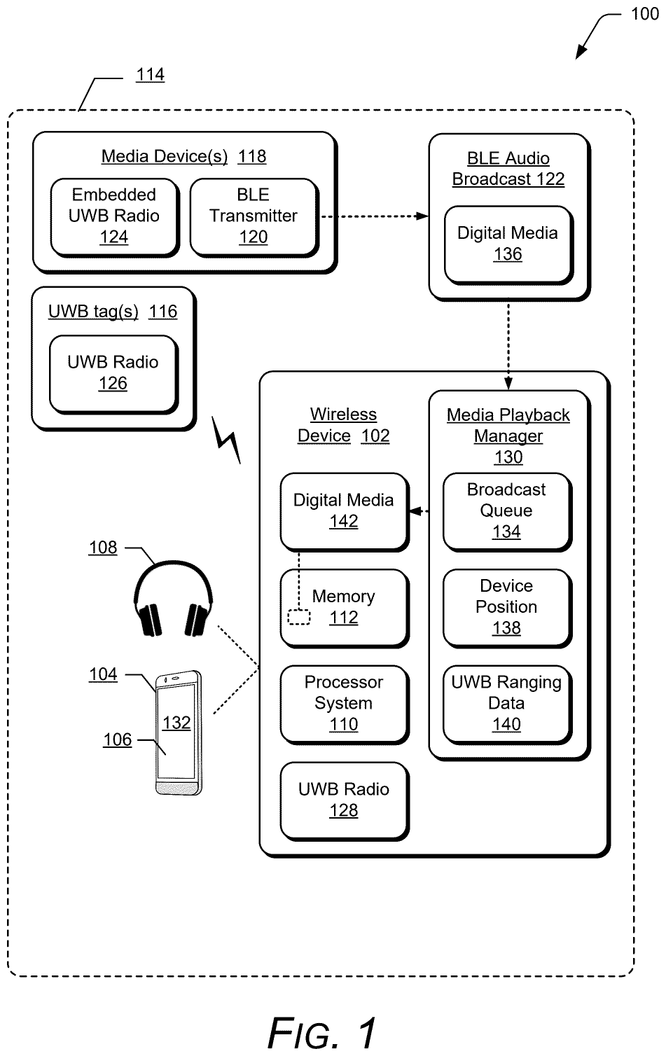

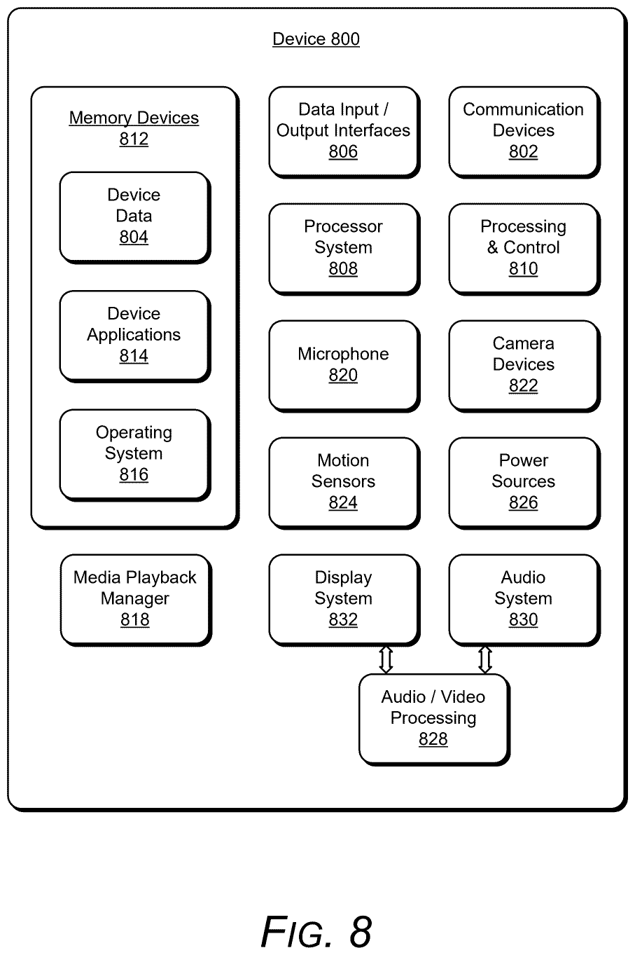

FIG. 1 illustrates an example system 100 for automatic selection of audio broadcast based on direction, as described herein. Generally, the system 100 includes a wireless device 102, which can be utilized to implement features and techniques of automatic selection of audio broadcast based on direction. In this example system 100, the wireless device 102 may be a mobile device 104 with a display screen 106, such as a smartphone, mobile phone, or other type of mobile wireless device. The wireless device 102 may also be a headphones 108, earphones, or any other type of portable speaker, which in implementations, may communicatively connect to the mobile device 104. Alternatively or in addition, the wireless device 102 may be any type of an electronic, computing, consumer, and/or communication device, such as a computer, a laptop device, a tablet, a wireless device, a camera device, a smart device, a media device, a headphone set, an earphone set, and so forth. The wireless device 102 can be implemented with various components, such as a processor system 110 and memory 112, as well as any number and combination of different components as further described with reference to the example device shown in FIG. 8. For example, the wireless device 102 can include a power source to power the device, such as a rechargeable battery and/or any other type of active or passive power source that may be implemented in an electronic, computing, and/or communication device.

In implementations, the wireless device 102 may be communicatively linked, generally by wireless connection, to UWB radios of UWB tags and/or to other UWB-enabled devices for UWB communication in an environment 114. Generally, the environment 114 can include the wireless device 102, media devices (e.g., display screens), the UWB tags 116, and other UWB-enabled devices implemented with a UWB radio for communication utilizing UWB, as well as any number of the other types of UWB-enabled devices described herein. The wireless UWB communications in the environment 114 are similar between the UWB tags 116 and/or other UWB-enabled devices, such as the media devices 118, in the environment. The UWB tags 116 can be integrated and/or placed in the environment proximate each of the media devices, and labeled with a functional name to indicate a UWB tag association with a particular device.

In this example system 100, the media devices 118 include a Bluetooth Low Energy (BLE) transmitter 120 capable of transmitting a BLE audio broadcast 122. In one or more implementations, the BLE transmitter 120 in this example can be configured for Auracast, which is a Bluetooth capability to audio broadcast to in-range receivers in multiple devices at once. For example, the BLE transmitter 120 transmits the BLE audio broadcast 122, which can be received by a receiver of the wireless device 102, such as received by the mobile device 104, the headphones 108, earphones, or any other portable wireless speaker-type of device. The BLE audio broadcast 122 may include any form of audio communication, such as news media, entertainment, information, or music. In some examples, the BLE audio broadcast 122 is secured with a password for encryption or is publicly accessible. For example, the BLE transmitter 120 can be implemented in a display screen displaying video playback and transmits the BLE audio broadcast 122, which includes audio content that accompanies the video playback, such as in some examples, to a user's wireless device for playback of the audio content. In some example situations, however, multiple BLE audio broadcasts are available, and the user is generally tasked with selecting one of the multiple BLE audio broadcasts. With limited knowledge of which of the multiple BLE audio broadcasts are relevant to the user, this selection can be difficult for the user.

To facilitate selection of the BLE audio broadcast 122, the media devices 118 in this example system 100 are also be enabled for UWB communications with an embedded UWB radio 124. Alternatively, a UWB tag 116 having a UWB radio 126 may be associated with any a media device 118 that is not UWB-enabled in the environment 114. Similarly, a UWB tag 116 may be associated with any other type of device in the environment, to include any type of a smart device, media device, mobile device, wireless device, and/or electronic device, as well as associated with a static object or device that is not enabled for wireless communications.

A network of the UWB tags 116 in the environment 114 can discover and communicate between themselves and/or with a control device or controller logic that manages the media devices 118 and UWB tags in the environment. In implementations, a UWB tag 116 can be used at a fixed location to facilitate accurate location, mapping, and positioning of other devices and/or areas in the environment 114.

The wireless device 102 can communicate with the UWB tags 116 and the embedded UWB radios 124 of the media devices 118 in the environment, and receive BLE or Bluetooth position information from the UWB tags and UWB radios of the devices. The wireless device 102 may be a centralized controller and/or a mobile device in the environment that correlates a UWB tag 116 with a media device 118 that is nearby based on RSSI measurements of the BLE or Bluetooth position information from the UWB tags and devices. For example, the wireless device 102 can receive position information from a UWB tag 116 or other UWB-enabled media device, and compare the signal path loss from the received signals to determine that the UWB tag and device are proximate each other in the environment 114 based on similar signal path loss.

In this example system 100, a UWB tag 116 is generally representative of any UWB tag or device with embedded UWB in the environment 114, and can include various radios for wireless communications with other devices and/or with the other UWB tags in the environment. For example, the UWB tag 116 can include a UWB radio 126, as well as any other types of radio devices, such as a Bluetooth radio, a Wi-Fi radio, and/or a global positioning system (GPS) radio implemented for wireless communications with the other devices and UWB tags in the environment 114. The wireless device 102 can also include various radios for wireless communication with the media devices 118 and/or with the UWB tags 116 in the environment. For example, the wireless device 102 includes a UWB radio 128 and may include other radio devices, such as a Bluetooth radio, a Wi-Fi radio, and a GPS radio implemented for wireless communications with the other devices and UWB tags 116 in the environment 114.

In implementations, the wireless device 102, the media devices 118, and/or the UWB tags 116 may include any type of positioning system, such as a GPS transceiver or other type of geo-location device, to determine the geographical location of a UWB tag 116, a media device 118, and/or the wireless device 102. Notably, any of the devices described herein, to include components, modules, services, computing devices, camera devices, and/or the UWB tags, can share the GPS data between any of the devices, whether they are GPS-hardware enabled or not. Although the resolution of global positioning is not as precise as the local positioning provided by UWB, the GPS data that is received by the GPS-enabled devices can be used for confirmation that the devices are all generally located in the environment 114, which is confirmed by the devices that are also UWB-enabled and included in the environment mapping. The GPS location of devices can be determined based on their relative position in the environment 114 and their proximity to the GPS-enabled devices. Accordingly, changes in location of both GPS-enabled devices and non-GPS devices can be tracked based on global positioning and local positioning in the environment.

In the example system 100 for automatic selection of audio broadcast based on direction, the wireless device 102 implements a media playback manager 130 (e.g., as a device application). As shown in this example, the media playback manager 130 represents functionality (e.g., logic, software, and/or hardware) enabling aspects of the described techniques for automatic selection of audio broadcast based on direction. The media playback manager 130 can be implemented as computer instructions stored on computer-readable storage media and can be executed by a processor system of the wireless device 102. Alternatively, or in addition, the media playback manager 130 can be implemented at least partially in hardware of the device.

In one or more implementations, the media playback manager 130 includes independent processing, memory, and/or logic components functioning as a computing and/or electronic device integrated with the wireless device 102. In this example, the media playback manager 130 is implemented as a software application or module, such as executable software instructions (e.g., computer-executable instructions) that are executable with a processor system (e.g., with the processor system 110) of the wireless device 102 to implement the techniques and features for automatic selection of audio broadcast based on direction, as described herein. As a software application or module, the media playback manager 130 can be stored on computer-readable storage memory (e.g., the memory 112 of the device), or in any other suitable memory device or electronic data storage implemented with the manager. Alternatively or in addition, the media playback manager 130 may be implemented in firmware and/or at least partially in computer hardware. For example, at least part of the media playback manager is executable by a computer processor, and/or at least part of the media playback manager is implemented in logic circuitry.

Although the media playback manager 130 is shown and described as being implemented by the wireless device 102 in the environment 114, any of the other devices in the environment may implement the media playback manager 130 and/or an instantiation of the media playback manager 130. For example, a control device or controller logic in the environment 114 can implement the media playback manager 130.

As a device application implemented by the wireless device 102, the media playback manager 130 may be associated with an application user interface 132 that is generated and displayed for user interaction and viewing, such as on the display screen 106 of the wireless device 102. Generally, an application user interface 132, or any other type of video, image, graphic, and the like is digital image content that is displayable on the display screen 106 of the wireless device 102. The media playback manager 130 can generate and initiate to display a broadcast queue 134 in the application user interface 132 on the display screen 106 of the wireless device 102 for user viewing in the environment. A broadcast queue 134 is a determined playback order of individual BLE audio broadcasts. For instance, the broadcast queue 134 specifies a first BLE audio broadcast for playback before a second BLE audio broadcast. Playback of the second BLE audio broadcast is automatically initiated at the wireless device 102 following conclusion of the first BLE audio broadcast.

In this example, the media devices 118 broadcast digital media 136 via the BLE audio broadcast 122 that is accessible for playback on the wireless device 102 in the environment. For example, the digital media 136 that is accessible for playback from the media devices 118 may be audio digital media, and the media playback manager 130 can receive the audio digital media for playback at an audio playback media device in the environment. Similarly, the digital media 136 that is accessible for playback from the media devices 118 may be video digital media, and the media playback manager 130 can receive the video digital media for playback at the video playback media device in the environment. Alternatively or in addition, the digital media may be accessible from a network server device for playback on the media device in the environment. The network-based (or cloud-based) digital media can be communicated from a network server device to the media device for the digital media playback of the digital media.

In the environment 114, a user of the wireless device 102 may carry the device (e.g., as the mobile device 104) around the environment, such as in a building. The media playback manager 130 can determine a location of each of the media devices 118 relative to a position of the person in the environment, such as based on a device position 138 of the wireless device 102 that the person carries relative to the location of each of the media devices 118 in the environment. For instance, the media playback manager 130 determines the position of the person as closest to the location of a media device 118 in the environment for digital media playback of the digital media to the wireless device 102, such as the closest location of the wireless device 102 to the media devices 118. In implementations, the media playback manager 130 can determine the position of a person and/or the location of a media device 118 in the environment utilizing the UWB ranging data, given that UWB time-of-flight (ToF), angle-of-arrival (AoA), and/or time-difference-of-arrival (TDoA) provides a vector of both range and direction.

Additionally, the media playback manager 130 can receive the audio digital media at the wireless device 102 for audio media playback based on which way a smart display or other television device is facing, taking into consideration the orientation of the person in the environment. Utilizing the UWB ranging data and AoA techniques, as well as sensors on a wireless device 102 and/or a captured image from a camera device associated with the wireless device 102 for example, the media playback manager 130 can determine the direction that a user's phone is facing, and the media device 118 from which to receive the digital media for media playback at the wireless device 102. The media playback manager 130 can receive orientation information that indicates an orientation of the person in the environment, and receive the digital media from the media device 118 that corresponds to the orientation of the person for viewing the digital media.

In implementations, the embedded UWB radio 124 in the media devices 118 in the environment 114, the UWB radio 128 in the wireless device 102, and the UWB ranging data 140, can provide the relative orientation between the UWB radios, as well as with additional sensors that indicate an orientation of the user who carries the wireless device 102 in the environment. For example, if the user carries the wireless device 102 in hand and is viewing the display screen of the device, then it is likely the UWB components of the device are facing the same or similar direction as the user, given the UWB antennas for AoA are positioned opposite the display in the device. Alternatively, if the wireless device 102 is carried in a pocket of the user, the display of the device likely faces outward and the device UWB components indicate that the user is facing in an opposite direction. The UWB antenna array in the wireless device 102, which is carried by a user, can be used as an indication of the orientation of the person in the environment, such as based on whether the user is facing normal to the device (0 degree angle), sideways to the device (90 degree angle), or facing away from the device (180 degree angle).

Other sensors of the device can also indicate a particular orientation of the wireless device 102 to the user, such as in a pocket and the device display is facing the body of the user, which would indicate that the UWB antenna array is pointed in the direction the user is moving. Alternatively, the device display may be facing outwards away from the body of the user, which would indicate that the UWB antenna array is pointed in an opposite direction to the vector of travel of the user. In other implementations utilizing sensors of the wireless device 102, the orientation of the user in the environment 114 may be determinable by the media playback manager 130 based on user face detection, eye gaze detection with a camera of the device, and/or with other types of sensors that sense proximity of the user. The media playback manager 130 can then receive the video digital media at a media device 118 for video media playback based on the user orientation and/or where the user is looking.

In implementations, the media playback manager 130 can also determine the position of a person within a room of a building (e.g., the environment) that includes the location of the media device 118 for digital media playback of the digital media. Additionally, as the person moves the wireless device 102 (e.g., mobile device 104) within the building environment, such as from room to room, the media playback manager 130 can determine a subsequent position of the wireless device within a different room of the building, and change the receival of the digital media from the media devices 118 in the room to a different media device in the different room, based on the determined subsequent position of the person in the environment relative to the location of the different media device.

The media playback manager 130 maintains the broadcast queue 134 of media devices 118, and digital content, such as the digital media 136 (e.g., audio, video, and/or audio/video) can be queued for playback at the wireless device 102 based on user location and/or orientation in the environment, the device position 138 in the environment, the time of day, the importance of the broadcast, any other type of determined scenario, and/or based on determined user intent. In implementations, the media playback manager 130 can auto-select the media devices 118 based on the broadcast queue 134 of ordered and selected media devices in the environment for playback at the wireless device 102.

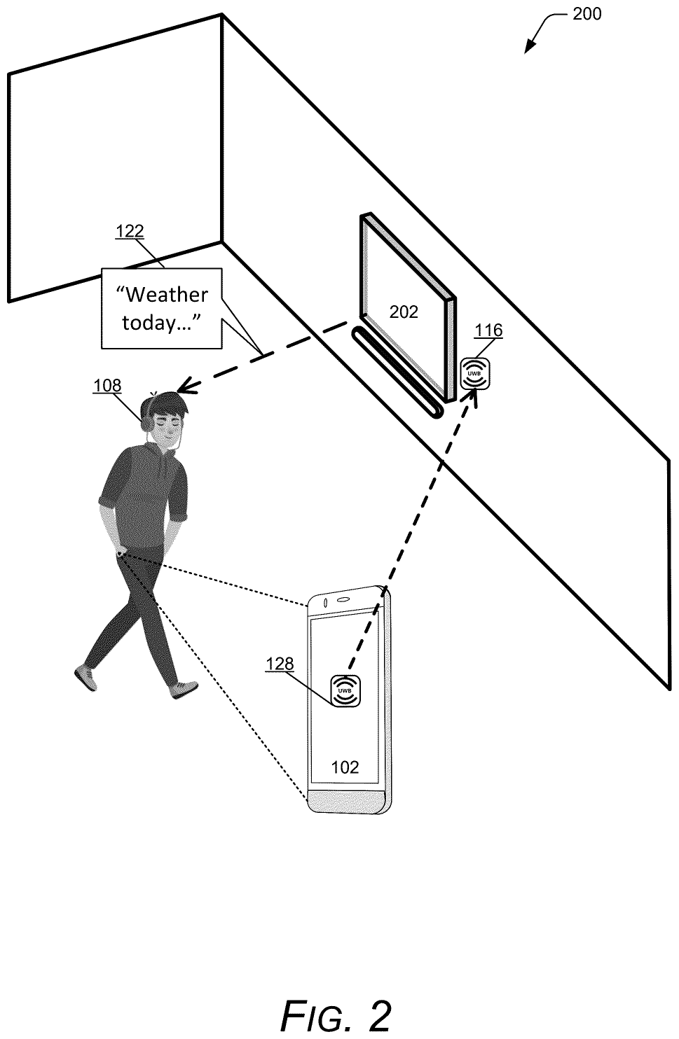

FIG. 2 illustrates an example 200 of automatic selection of audio broadcast based on direction, as shown and described with reference to FIG. 1. In this example 200, a display device 202 is associated with a UWB tag 116 or includes an embedded UWB radio 124. The display device 202 is an example of a media device 118 that includes a BLE transmitter 120 capable of transmitting a BLE audio broadcast 122, which is a weather report in this example. The display device 202 may display visual content corresponding to the BLE audio broadcast 122, but speakers associated with the display device 202 are muted. Instead, users are able to listen to the BLE audio broadcast 122 using a personal device that receives the BLE audio broadcast 122 for playback at the wireless device 102.

In this example, a user within broadcast range of the display device 202 carries a wireless device 102 implemented with an embedded UWB radio 124 and wears headphones 108 paired with the wireless device 102. The wireless device 102 is configured with a media playback manager 130, as shown and described with reference to FIG. 1, to detect the BLE audio broadcast 122. To determine whether to receive the BLE audio broadcast 122 for playback at the wireless device 102 for playback of the BLE audio broadcast 122, the media playback manager 130 determines a position of the wireless device 102 relative to the display device 202. The media playback manager 130 receives the BLE audio broadcast 122 if, for example, the display device 202 is positioned within a threshold distance to the wireless device 102. In other examples, the media playback manager 130 receives the BLE audio broadcast 122 if the user is facing the display device 202, or based on any other criteria.

To determine the position of the wireless device 102 relative to the display device 202, the wireless device 102 communicates via the UWB radio 128 with the UWB tag 116 associated with the display device 202 in the environment. Similarly, the wireless device 102 can also communicate via a Bluetooth radio and/or a Wi-Fi radio with other media devices and/or the devices in the environment, such as additional display devices. Although this example described with reference to the wireless device 102 implementing the media playback manager 130, it should be noted that the headphones 108 may also implement the media playback manager 130 and operate independently or in conjunction with the media playback manager 130 as implemented by the wireless device 102.

The media playback manager 130 receives (via the wireless device 102) the BLE or Bluetooth position information from the UWB tag 116. The media playback manager 130 can then correlate the wireless device 102 with the UWB tag 116 based on RSSI measurements of the BLE or Bluetooth position information from the UWB tag 116. Based on the BLE or Bluetooth position information from the UWB tag 116, the media playback manager 130 determines a position of the display device 202 relative to the wireless device 102. For example, the media playback manager 130 is preconfigured based on user input to automatically receive the BLE audio broadcast 122 when the wireless device 102 is within ten feet of a media device 118 that is broadcasting the BLE audio broadcast 122. In this example, the media playback manager 130 determines that the display device 202 is six feet from the wireless device 102 and therefore automatically receives the BLE audio broadcast 122 for playback at the wireless device 102. In this example, the wireless device 102 is configured to initiate automatic playback of the BLE audio broadcast 122 via the headphones 108 worn by the user and paired with the wireless device 102.

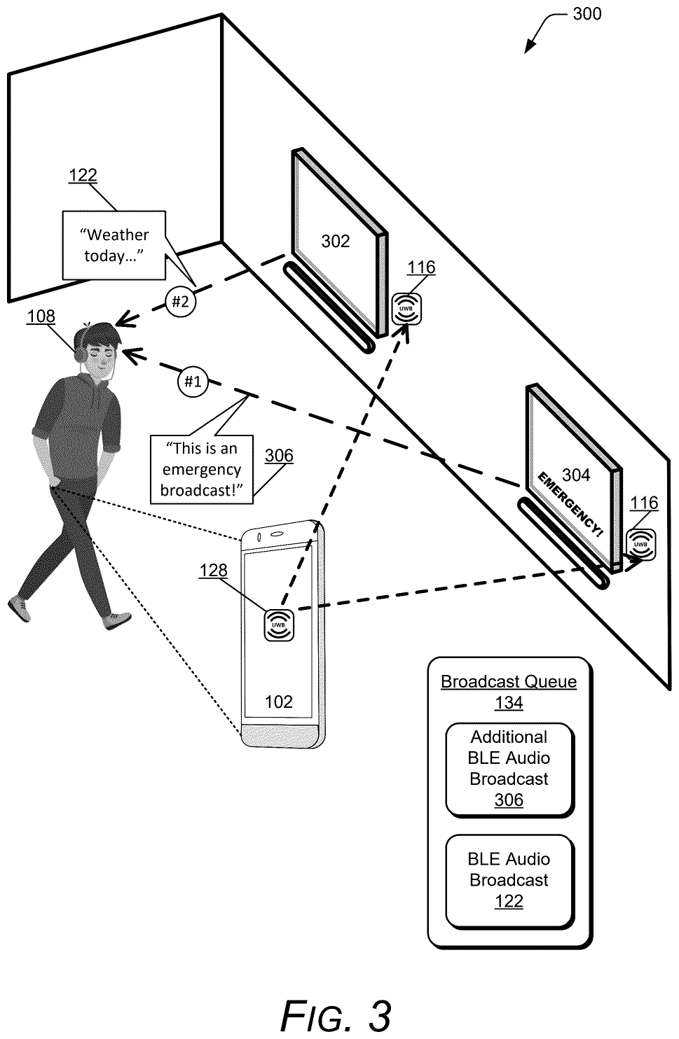

FIG. 3 illustrates an example 300 of automatic selection of audio broadcast based on direction and a broadcast queue, as shown and described with reference to FIG. 1. In this example 300, a display device 302 and an additional display device 304 are associated with respective UWB tags 116. In this example, the display device 302 is an example of a media device 118 that includes a BLE transmitter 120 and is capable of transmitting a BLE audio broadcast 122, such as a weather report. Similarly, the additional display device 304 is an example of a media device 118 that includes a BLE transmitter 120 and is capable of transmitting an additional BLE audio broadcast 306, such as an emergency report. Both the display device 302 and the additional display device 304 may display visual content corresponding to the BLE audio broadcast 122 and the additional BLE audio broadcast 306, respectively. Speakers associated with the display devices may be muted or set to a very low output. Instead, users are able to listen to the BLE audio broadcast 122 or the additional BLE audio broadcast 306 using a personal device, such as any type of wireless device 102, that receives the BLE audio broadcast 122 or the additional BLE audio broadcast 306 for playback at the wireless device 102.

In this example, a user within broadcast range of both the display device 302 and the additional display device 304 carries a wireless device 102 implemented with a UWB radio 128 and wears headphones 108 paired with the wireless device 102. The wireless device 102 is configured with a media playback manager 130 to detect both the BLE audio broadcast 122 and the additional BLE audio broadcast 306. However, because both the BLE audio broadcast 122 and the additional BLE audio broadcast 306 are available for playback, the media playback manager 130 determines a broadcast queue 134, which is a determined order for playback of individual available BLE broadcasts. The broadcast queue 134 is determined based on any predetermined criteria, such as determined broadcast importance in this example.

To determine the relative importance of the BLE audio broadcast 122 and the additional BLE audio broadcast 306, the media playback manager 130 extracts metadata from the BLE audio broadcast 122. Metadata corresponding to the BLE audio broadcast 122 indicates the BLE audio broadcast 122 is a weather report, and metadata corresponding to the additional BLE audio broadcast 306 indicates the additional BLE audio broadcast 306 is an emergency report. Based on the predetermined criteria, the media playback manager 130 ranks the additional BLE audio broadcast 306 as having a higher level or importance than the BLE audio broadcast 122. The media playback manager 130 therefore generates the broadcast queue 134, specifying playback of the additional BLE audio broadcast 306 before playback of the BLE audio broadcast 122.

In some examples, the media playback manager 130 additionally receives (via the wireless device 102) the BLE or Bluetooth position information from the UWB tags 116 corresponding to the display device 302 and the additional display device 304. The media playback manager 130 can then correlate the wireless device 102 with the UWB tags 116 based on RSSI measurements of the BLE or Bluetooth position information from the UWB tag 116. Based on the BLE or Bluetooth position information from the UWB tag 116, the media playback manager 130 determines a position of the display device 302 and the additional display device 304 relative to the wireless device 102. For example, the media playback manager 130 is preconfigured based on user input to automatically receive the top BLE broadcast of the broadcast queue 134 when the wireless device 102 is within a predetermined distance of a media device 118 that is broadcasting a BLE audio broadcast. In this example, the media playback manager 130 determines that the display device 302 and the additional display device 304 are both within the threshold distance from the wireless device 102 and therefore automatically receive the additional BLE audio broadcast 306 to the wireless device 102 for playback at the wireless device 102 based on the broadcast queue 134. In this example, the wireless device 102 is configured to initiate playback of the BLE audio broadcast 122 via the headphones 108 worn by the user and paired with the wireless device 102.

In other examples, the media playback manager 130 determines the broadcast queue 134 based on which of the media devices 118 are closest to the wireless device 102. For example, the UWB tag 116 can generate an ordered list of devices and/or media devices 118 that are proximate based on RSSI and/or reported transmission power to assess which of the devices is the closest to the UWB tags 116. The media playback manager 130 implemented by the wireless device 102 can also compare the UWB tag reports against its own database of device identifying information and UWB tag identifiers in some examples. Notably, a user can override any of the UWB tag and device determined associations, either by a UWB tag itself or by the media playback manager 130, and the user can then designate which one of the UWB tags 116 is associated with a particular device or object.

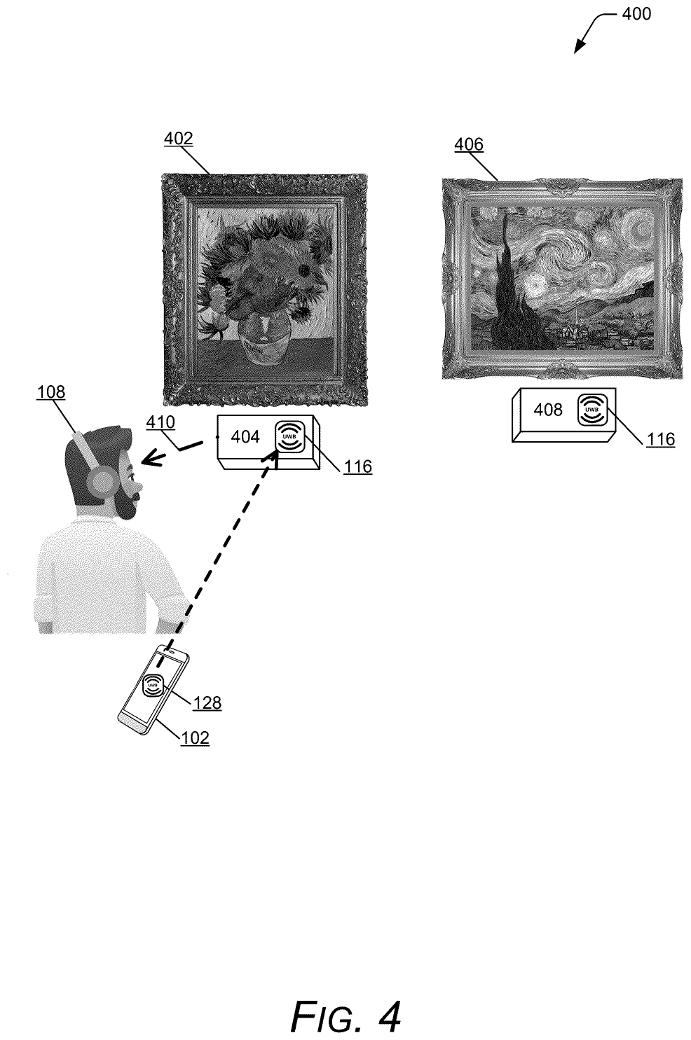

FIG. 4 illustrates an example 400 of automatic selection of audio broadcast based on direction, as shown and described with reference to FIG. 1. In this example 400, an art gallery includes framed paintings equipped with UWB tags 116 and devices capable of broadcasting BLE audio broadcasts. For example, a first painting frame 402 is equipped with a first BLE transmitter 404, and a second painting frame 406 is equipped with a second BLE transmitter 408. The first BLE transmitter 404 and the second BLE transmitter 408 are capable of transmitting different BLE audio broadcasts that describe the respective paintings associated with the first BLE transmitter 404 and the second BLE transmitter 408.

In this example, a user within broadcast range of the first BLE transmitter 404 and the second BLE transmitter 408 carries a wireless device 102 implemented with a UWB radio 128 and wears headphones 108 paired with the wireless device 102. The wireless device 102 is configured with a media playback manager 130 to detect the BLE audio broadcasts. Because the BLE audio broadcasts describe the respective paintings associated with the first BLE transmitter 404 and the second BLE transmitter 408, the media playback manager 130 is configured to receive a BLE audio broadcast at the wireless device 102 corresponding to a painting the user is facing. To determine which painting and associated BLE transmitter the user is facing, the media playback manager 130 determines a position of the wireless device 102 relative to the first painting frame 402 and the second painting frame 406. The media playback manager 130 receives a first BLE audio broadcast 410 corresponding to the first painting frame 402 for playback at the wireless device 102 if, for example, the user is facing the first painting frame 402.

To determine the position of the wireless device 102 relative to the first painting frame 402 and the second painting frame 406, the wireless device 102 communicates via the UWB radio 128 with the UWB tags 116 associated with the first painting frame 402 and the second painting frame 406 in the environment. Similarly, the wireless device 102 can also communicate via a Bluetooth radio and/or a Wi-Fi radio with other media devices and/or the devices in the environment, such as additional display devices. Although this example described with reference to the wireless device 102 implementing the media playback manager 130, it should be noted that the headphones 108 may also implement the media playback manager 130 and operate independently or in conjunction with the media playback manager 130 as implemented by the wireless device 102.

In this example, the UWB tags 116 are associated with the first painting frame 402 and the second painting frame 406. In other examples, the UWB tag 116 is associated with any media devices 118, objects, and/or the devices in the environment. An operational mode of the UWB tags 116 can be enabled, as well as an advertising mode, discoverable mode, or other type of operational mode initiated on the devices and/or media devices 118. The media playback manager 130 can initiate to query the UWB tags 116 for a BLE MAC ADDR report, device name, RSSIs, and any other type of device identifying information.

The media playback manager 130 receives (via the wireless device 102) the BLE or Bluetooth position information from the UWB tags 116. The media playback manager 130 can then correlate the wireless device 102 with the UWB tags 116 based on RSSI measurements of the BLE or Bluetooth position information from the UWB tags 116. Based on the BLE or Bluetooth position information from the UWB tag 116, the media playback manager 130 determines a position of the first painting frame 402 and the second painting frame 406 relative to the wireless device 102.

Based on an angle of arrival between the UWB tags 116 and the UWB radio 128 of the wireless device 102, the media playback manager 130 determines the relative location of the wireless device 102 to the first painting frame 402 or the second painting frame 406. The media playback manager 130 then determines a direction the user is facing. If the media playback manager 130 detects the user is actively holding the wireless device 102, for example, the media playback manager 130 determines the user is facing the wireless device 102. Likewise, if the media playback manager 130 detects that wireless device 102 is stored in the user's pocket, the media playback manager 130 determines a direction the user is facing based on the location of the wireless device 102 in the user's pocket. The media playback manager 130 then determines which frame the user is facing based on the relative location of the wireless device 102 to the first painting frame 402 or the second painting frame 406 and the direction the user is facing. Although this example involves the angle of arrival between the UWB tags 116 and the UWB radio 128 of the wireless device 102, other examples contemplate an angle of arrival using directionally-aware protocols other than UWB, including, but not limited to Bluetooth (e.g., versions 5.1 and above), Wi-Fi standards such as 802.11ac and 802.11ax (e.g., Wi-Fi 5 and Wi-Fi 6), and cellular network standards such as 5G New Radio (NR).

For example, the media playback manager 130 is preconfigured in this example to automatically receive the BLE audio broadcast corresponding to the painting the user is facing. In this example, the media playback manager 130 determines that the user is facing the first painting frame 402. For example, the media playback manager 130 determines the user is nearby the first painting frame 402 based on the angle of arrival between the UWB tag 116 associated with the first painting frame 402 and the media playback manager 130. The media playback manager 130 also determines the user is facing the first painting frame 402 because the media playback manager 130 detects that the user is holding and actively using the wireless device 102, which is facing the known location of the first painting frame 402. The media playback manager 130 therefore receives a first BLE audio broadcast 410 from the first BLE transmitter 404 for playback at the wireless device 102, which aurally describes the first painting frame 402. In this example, the wireless device 102 is configured to initiate playback of the first BLE audio broadcast 410 via the headphones 108 worn by the user and paired with the wireless device 102.

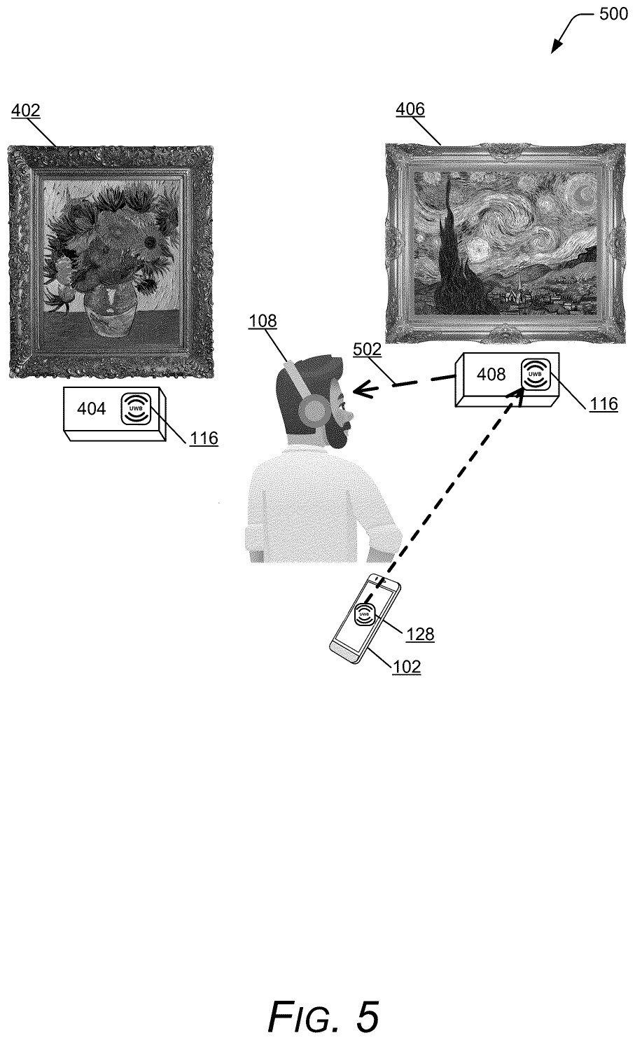

FIG. 5 illustrates an example 500 of automatic selection of audio broadcast based on direction, as shown and described with reference to FIG. 1 and FIG. 4. FIG. 5 is a continuation of the example 400 described with respect to FIG. 4. In this example 500, the user has moved in the art gallery and is now in a different position relative to the first painting frame 402 and the second painting frame 406.

The media playback manager 130 in this example is configured to detect a change in position of the wireless device 102 relative to the first painting frame 402 and the first BLE transmitter 404. Based on an angle of arrival between the UWB tags 116 and the UWB radio 128 of the wireless device 102, the media playback manager 130 determines the change of position of the wireless device 102 to the first painting frame 402 or the second painting frame 406. The media playback manager 130 then determines an updated direction that the user is facing. If the media playback manager 130 detects the user is actively holding the wireless device 102, for example, the media playback manager 130 determines the user is facing the wireless device 102. Likewise, if the media playback manager 130 detects that wireless device 102 is stored in the user's pocket, the media playback manager 130 determines a direction the user is facing based on the location of the wireless device 102 in the user's pocket. The media playback manager 130 then determines which frame the user is facing based on the relative location of the wireless device 102 to the first painting frame 402 or the second painting frame 406 and the direction the user is facing.

For example, the media playback manager 130 is preconfigured in this example to automatically end playback of the first BLE audio broadcast 410 at the wireless device 102 and receive a second BLE audio broadcast 502 for playback at the wireless device 102 if the user moves and is facing the second painting frame 406 instead of the first painting frame 402. In this example, the media playback manager 130 determines that the user is now facing the second painting frame 406. For example, the media playback manager 130 determines the user is nearby the second painting frame 406 based on the angle of arrival between the UWB tag 116 associated with the second painting frame 406 and the media playback manager 130. The media playback manager 130 also determines the user is facing the second painting frame 406 because the media playback manager 130 detects that the user is holding and actively using the wireless device 102, which is facing the known location of the second painting frame 406. The media playback manager 130 therefore terminates playback of the first BLE audio broadcast 410 from the first BLE transmitter 404 at the wireless device 102 and instead receives the second BLE audio broadcast 502 from the second BLE transmitter 408 for playback at the wireless device 102, which aurally describes the second painting frame 406. In this example, the wireless device 102 is configured to initiate playback of the second BLE audio broadcast 502 via the headphones 108 worn by the user and paired with the wireless device 102.

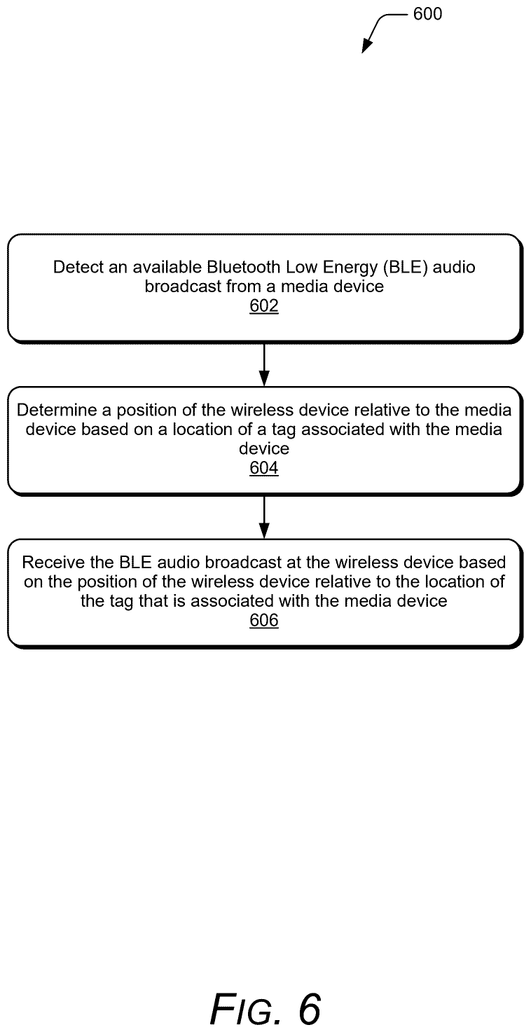

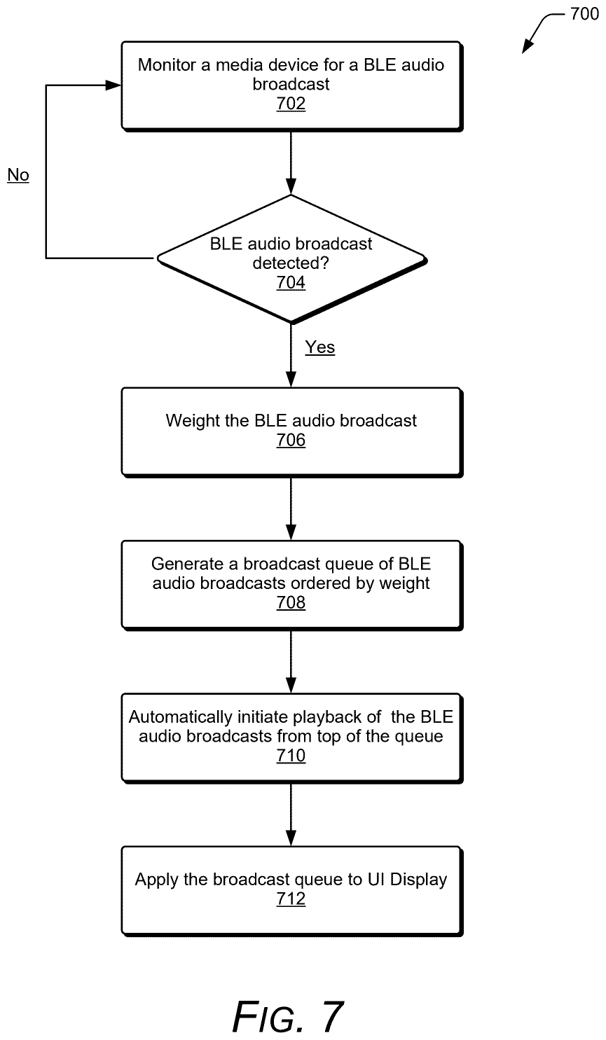

Example methods 600 and 700 are described with reference to respective FIGS. 6 and 7 in accordance with implementations for automatic selection of audio broadcast based on direction. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 6 illustrates example method(s) 600 for automatic selection of audio broadcast based on direction, and is generally described with reference to a media playback manager implemented by a computing device. The order in which the method is described is not intended to be construed as a limitation, and any number or combination of the described method operations can be performed in any order to perform a method, or an alternate method.

At 602, an available Bluetooth Low Energy (BLE) audio broadcast from a media device is detected. For example, the media playback manager 130 implemented by the wireless device 102 (e.g., an example of the mobile device 104) detects an available Bluetooth Low Energy (BLE) audio broadcast 122 from a media device.

At 604, a position of the wireless device relative to the media device is determined based on a location of a tag associated with the media device. For example, the media playback manager 130 implemented by the wireless device 102 determines a position of the wireless device 102 relative to the media device based on a location of a tag associated with the media device. In some implementations, the position of the wireless device 102 relative to the media device is determined based on an angle of arrival between the tag and a UWB positioning system associated with the wireless device 102. For example, the UWB positioning system associated with the wireless device 102 is implemented in headphones 108 worn by a user, and the angle of arrival indicates a user orientation is facing toward the media device. Additionally or alternatively, the UWB positioning system is implemented in the wireless device 102 carried by a user, and the angle of arrival indicates a user orientation is facing toward the media device.

At 606, the BLE audio broadcast is received at the wireless device based on the position of the wireless device relative to the location of the tag that is associated with the media device. For example, the media playback manager 130 implemented by the wireless device 102 receives the BLE audio broadcast 122 at the wireless device based on the position of the wireless device 102 relative to the location of the tag that is associated with the media device. In some examples, the media playback manager 130 is configured to assign a weight for the BLE audio broadcast 122 based on metadata associated with the BLE audio broadcast 122. For example, the media playback manager 130 is configured to determine a queue of multiple BLE broadcasts based on the weight for the BLE audio broadcast 122 and an assigned weight for at least one additional BLE audio broadcast. In some implementations, one of the multiple BLE audio broadcasts is associated with an emergency event and is assigned priority in the broadcast queue 134. Additionally or alternatively, the tag is an Ultra-Wideband (UWB) tag 116 and the media playback manager 130 is configured to detect a change in the position of the wireless device 102 relative to the location of the UWB tag 116 and stop receiving the BLE audio broadcast 122 at the wireless device 102. For example, the media playback manager 130 is configured to detect an alternative available BLE audio broadcast from an alternative media device and receive the alternative BLE audio broadcast at the wireless device 102 for playback of the alternative BLE audio broadcast.

FIG. 7 illustrates an example method 700 of generating a queue of broadcast events for automatic selection of audio broadcast based on direction, as shown and described with reference to FIG. 3. The order in which the method is described is not intended to be construed as a limitation, and any number or combination of the described method operations may be performed in any order to perform a method, or an alternate method.

At 702, a media device is monitored for a BLE audio broadcast. A media playback manager 130 implemented by a wireless device 102 monitors a BLE transmitter 120 associated with a media device 118 for a BLE audio broadcast 122 that is available for playback.

At 704, a determination is made as to whether the BLE audio broadcast is detected. The media playback manager 130 implemented by the wireless device 102 determines whether a BLE transmitter 120 within range of the wireless device 102 is transmitting the BLE audio broadcast 122. If the media playback manager 130 detects the BLE audio broadcast 122 (i.e., “Yes” from 704), then the process continues to 706. If the media playback manager 130 is not detected, (i.e., “No” from 704), then the process returns to 702, and the media playback manager 130 continues to monitor for the BLE audio broadcast 122.

At 706, the BLE audio broadcast is weighted. The media playback manager 130 implemented by the wireless device 102 detects or identifies metadata associated with the BLE audio broadcast 122. The metadata includes information describing the BLE audio broadcast 122, including a type of broadcast. Based on predetermined criteria, the media playback manager 130 weights the BLE audio broadcast 122 according to importance or relevance. For example, a higher weight indicates a higher level of importance, and a lower weight indicates a lower level of importance.

At 708, a broadcast queue is generated of BLE audio broadcasts ordered by weight. The media playback manager 130 implemented by the wireless device 102 generates a broadcast queue 134 that is an ordered list of BLE audio broadcasts according to a planned sequence of playback. The media playback manager 130 lists BLE broadcasts with a higher rank at a top of the broadcast queue 134, for example. The BLE audio broadcasts at the top of the broadcast queue 134 are played before the BLE audio broadcasts at the bottom of the broadcast queue 134.

At 710, playback of the BLE audio broadcasts is automatically initiated from a top of the broadcast queue 134. The media playback manager 130 implemented by the wireless device 102 receives the BLE audio broadcast 122, which is at the top of the broadcast queue 134, from the BLE transmitter 120 for playback at the wireless device 102. In some examples, the media playback manager 130 is implemented in headphones 108 worn by a user that is configured to output playback of the BLE audio broadcast 122.

At 712, the broadcast queue 134 is applied to a UI display. The media playback manager 130 implemented by the wireless device 102 generates a UI for display on a display screen of the wireless device 102 indicating the order of BLE audio broadcasts in the broadcast queue 134. The UI includes prompts configured to receive user input for the media playback manager 130 to manually change the order of BLE audio broadcasts in the broadcast queue 134.

FIG. 8 illustrates various components of an example device 800, which can implement aspects of the techniques and features for automatic selection of audio broadcast based on direction, as described herein. The example device 800 can be implemented as any of the devices described with reference to the previous FIGS. 1-7, such as any type of a wireless device, including a mobile device, mobile phone, flip phone, client device, companion device, paired device, display device, tablet, computing, communication, entertainment, gaming, media playback, and/or any other type of computing and/or electronic device. For example, the wireless device 102 and/or a UWB tag 116 described with reference to FIGS. 1-7 may be implemented as the example device 800. The example device 800 can include various, different communication devices 802 that enable wired and/or wireless communication of device data 804 with other devices. The device data 804 can include any of the various devices data and content that is generated, processed, determined, received, stored, and/or communicated from one computing device to another. Generally, the device data 804 can include any form of audio, video, image, graphics, and/or electronic data that is generated by applications executing on a device. The communication devices 802 can also include transceivers for cellular phone communication and/or for any type of network data communication.

The example device 800 can also include various, different types of data input/output (I/O) interfaces 806, such as data network interfaces that provide connection and/or communication links between the devices, data networks, and other devices. The I/O interfaces 806 can be used to couple the device to any type of components, peripherals, and/or accessory devices, such as a computer input device that may be integrated with the example device 800. The I/O interfaces 806 may also include data input ports via which any type of data, information, media content, communications, messages, and/or inputs can be received, such as user inputs to the device, as well as any type of audio, video, image, graphics, and/or electronic data received from any content and/or data source.

The example device 800 includes a processor system 808 of one or more processors (e.g., any of microprocessors, controllers, and the like) and/or a processor and memory system implemented as a system-on-chip (SoC) that processes computer-executable instructions. The processor system 808 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that may be implemented in connection with processing and control circuits, which are generally identified at 810. The example device 800 may also include any type of a system bus or other data and command transfer system that couples the various components within the device. A system bus can include any one or combination of different bus structures and architectures, as well as control and data lines.

The example device 800 also includes memory and/or memory devices 812 (e.g., computer-readable storage memory) that enable data storage, such as data storage devices implemented in hardware which can be accessed by a computing device, and that provide persistent storage of data and executable instructions (e.g., software applications, programs, functions, and the like). Examples of the memory devices 812 include volatile memory and non-volatile memory, fixed and removable media devices, and any suitable memory device or electronic data storage that maintains data for computing device access. The memory devices 812 can include various implementations of random-access memory (RAM), read-only memory (ROM), flash memory, and other types of storage media in various memory device configurations. The example device 800 may also include a mass storage media device.

The memory devices 812 (e.g., as computer-readable storage memory) provide data storage mechanisms, such as to store the device data 804, other types of information and/or electronic data, and various device applications 814 (e.g., software applications and/or modules). For example, an operating system 816 can be maintained as software instructions with a memory device 812 and executed by the processor system 808 as a software application. The device applications 814 may also include a device manager, such as any form of a control application, software application, signal-processing and control module, code that is specific to a particular device, a hardware abstraction layer for a particular device, and so on.

In this example, the device 800 includes a media playback manager 818 that implements various aspects of the described features and techniques for automatic selection of audio broadcast based on direction. The media playback manager 818 can be implemented with hardware components and/or in software as one of the device applications 814, such as when the example device 800 is implemented as the wireless device 102 described with reference to FIGS. 1-7. An example of the media playback manager 818 includes the media playback manager 130 that is implemented by the wireless device 102, such as a software application and/or as hardware components in the computing device. In implementations, the media playback manager 818 may include independent processing, memory, and logic components as a computing and/or electronic device integrated with the example device 800.

The example device 800 can also include a microphone 820 and/or camera devices 822, as well as motion sensors 824, such as may be implemented as components of an inertial measurement unit (IMU). The motion sensors 824 can be implemented with various sensors, such as a gyroscope, an accelerometer, and/or other types of motion sensors to sense motion of the device. The motion sensors 824 can generate sensor data vectors having three-dimensional parameters (e.g., rotational vectors in x, y, and z-axis coordinates) indicating location, position, acceleration, rotational speed, and/or orientation of the device. The example device 800 can also include one or more power sources 826, such as when the device is implemented as a wireless device. The power sources may include a charging and/or power system, and can be implemented as a flexible strip battery, a rechargeable battery, a charged super-capacitor, and/or any other type of active or passive power source.

The example device 800 can also include an audio and/or video processing system 828 that generates audio data for an audio system 830 and/or generates display data for a display system 832. The audio system and/or the display system may include any types of devices or modules that generate, process, display, and/or otherwise render audio, video, display, and/or image data. Display data and audio signals can be communicated to an audio component and/or to a display component via any type of audio and/or video connection or data link. In implementations, the audio system and/or the display system are integrated components of the example device 800. Alternatively, the audio system and/or the display system are external, peripheral components to the example device.

Although implementations for automatic selection of audio broadcast based on direction have been described in language specific to features and/or methods, the appended claims are not necessarily limited to the specific features or methods described. Rather, the specific features and methods are disclosed as example implementations for automatic selection of audio broadcast based on direction, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In some aspects, the techniques described herein relate to a wireless device, including: at least one processor coupled with a memory, and a media playback manager configured to cause the wireless device to: detect an available Bluetooth Low Energy (BLE) audio broadcast from a media device, determine a position of the wireless device relative to the media device based on a location of a tag associated with the media device, and receive the BLE audio broadcast at the wireless device based on the position of the wireless device relative to the location of the tag that is associated with the media device.

In some aspects, the techniques described herein relate to a wireless device, wherein the media playback manager is configured to assign a weight for the BLE audio broadcast based on metadata associated with the BLE audio broadcast.

In some aspects, the techniques described herein relate to a wireless device, wherein the media playback manager is configured to determine a queue of multiple BLE broadcasts based on the weight for the BLE audio broadcast and an assigned weight for at least one additional BLE audio broadcast.

In some aspects, the techniques described herein relate to a wireless device, wherein one of the multiple BLE audio broadcasts is associated with an emergency event and is assigned priority in the queue.

In some aspects, the techniques described herein relate to a wireless device, wherein the tag is an Ultra-Wideband (UWB) tag and the media playback manager is configured to detect a change in the position of the wireless device relative to the location of the UWB tag and stop receiving the BLE audio broadcast at the wireless device.

In some aspects, the techniques described herein relate to a wireless device, wherein the media playback manager is configured to detect an alternative available BLE audio broadcast from an alternative media device and receive the alternative BLE audio broadcast at the wireless device for playback of the alternative BLE audio broadcast.

In some aspects, the techniques described herein relate to a wireless device, wherein the position of the wireless device relative to the media device is determined based on an angle of arrival between the tag and a UWB positioning system associated with the wireless device.

In some aspects, the techniques described herein relate to a wireless device, wherein the UWB positioning system associated with the wireless device is implemented in a headphone worn by a user, and the angle of arrival indicates a user orientation is facing toward the media device.

In some aspects, the techniques described herein relate to a wireless device, wherein the UWB positioning system is implemented in the wireless device carried by a user, and the angle of arrival indicates a user orientation is facing toward the media device.

In some aspects, the techniques described herein relate to a method, including: communicating, by a wireless device, with tags associated with respective media devices in an environment, determining a position of each of the media devices in the environment based on a position of a tag associated with a respective media device, and receiving a BLE audio broadcast from a media device based on a position of the wireless device relative to the position of the tag that is associated with the media device.

In some aspects, the techniques described herein relate to a method, further including assigning a weight for the BLE audio broadcast based on metadata associated with the BLE audio broadcast.

In some aspects, the techniques described herein relate to a method, further including determining a queue of multiple BLE broadcasts based on the weight for the BLE audio broadcast and an assigned weight for at least one additional BLE audio broadcast.

In some aspects, the techniques described herein relate to a method, wherein one of the multiple BLE audio broadcasts is associated with an emergency event and is assigned priority in the queue.

In some aspects, the techniques described herein relate to a method, wherein the tag is an ultra-wideband (UWB) tag and the position of the wireless device relative to the media device is determined based on an angle of arrival between the UWB tag and a UWB positioning system associated with the wireless device.

In some aspects, the techniques described herein relate to a method, wherein the UWB positioning system associated with the wireless device is implemented in a headphone worn by a user, and the angle of arrival indicates a user orientation is facing toward the media device.

In some aspects, the techniques described herein relate to a method, wherein the UWB positioning system associated with the wireless device is implemented in the wireless device carried by a user, and the angle of arrival indicates a user orientation is facing toward the media device.

In some aspects, the techniques described herein relate to a system, including: location-based tags associated with respective media devices in an environment, and a media playback manager implemented by a wireless device and configured to: detect an available Bluetooth Low Energy (BLE) audio broadcast from a media device, determine a position of the wireless device relative to the media device based on a location of a location-based tag associated with the media device, and receive the BLE audio broadcast at the wireless device based on the position of the wireless device relative to the location of the location-based tag that is associated with the media device.

In some aspects, the techniques described herein relate to a system, wherein the media playback manager is configured to assign a weight for the BLE audio broadcast based on metadata associated with the BLE audio broadcast.

In some aspects, the techniques described herein relate to a system, wherein the media playback manager is configured to determine a queue of multiple BLE broadcasts based on the weight for the BLE audio broadcast and an assigned weight for at least one additional BLE audio broadcast.

In some aspects, the techniques described herein relate to a system, wherein one of the multiple BLE audio broadcasts is associated with an emergency event and is assigned priority in the queue.

1. A wireless device, comprising:
at least one processor coupled with a memory; and
a media playback manager configured to cause the wireless device to:
detect an available Bluetooth Low Energy (BLE) audio broadcast from a media device;
determine a position of the wireless device relative to the media device based on a location of a tag associated with the media device; and
receive the BLE audio broadcast at the wireless device based on the position of the wireless device relative to the location of the tag that is associated with the media device.

2. The wireless device of claim 1, wherein the media playback manager is configured to assign a weight for the BLE audio broadcast based on metadata associated with the BLE audio broadcast.

3. The wireless device of claim 2, wherein the media playback manager is configured to determine a queue of multiple BLE broadcasts based on the weight for the BLE audio broadcast and an assigned weight for at least one additional BLE audio broadcast.

4. The wireless device of claim 3, wherein one of the multiple BLE audio broadcasts is associated with an emergency event and is assigned priority in the queue.

5. The wireless device of claim 1, wherein the tag is an Ultra-Wideband (UWB) tag and the media playback manager is configured to detect a change in the position of the wireless device relative to the location of the UWB tag and stop receiving the BLE audio broadcast at the wireless device.

6. The wireless device of claim 5, wherein the media playback manager is configured to detect an alternative available BLE audio broadcast from an alternative media device and receive the alternative BLE audio broadcast at the wireless device for playback of the alternative BLE audio broadcast.

7. The wireless device of claim 1, wherein the position of the wireless device relative to the media device is determined based on an angle of arrival between the tag and a UWB positioning system associated with the wireless device.

8. The wireless device of claim 7, wherein the UWB positioning system associated with the wireless device is implemented in a headphone worn by a user, and the angle of arrival indicates a user orientation is facing toward the media device.

9. The wireless device of claim 7, wherein the UWB positioning system is implemented in the wireless device carried by a user, and the angle of arrival indicates a user orientation is facing toward the media device.

10. A method, comprising:
communicating, by a wireless device, with tags associated with respective media devices in an environment;
determining a position of each of the media devices in the environment based on a position of a tag associated with a respective media device; and
receiving a BLE audio broadcast from a media device based on a position of the wireless device relative to the position of the tag that is associated with the media device.

11. The method of claim 10, further comprising assigning a weight for the BLE audio broadcast based on metadata associated with the BLE audio broadcast.

12. The method of claim 11, further comprising determining a queue of multiple BLE broadcasts based on the weight for the BLE audio broadcast and an assigned weight for at least one additional BLE audio broadcast.

13. The method of claim 12, wherein one of the multiple BLE audio broadcasts is associated with an emergency event and is assigned priority in the queue.

14. The method of claim 10, wherein the tag is an ultra-wideband (UWB) tag and the position of the wireless device relative to the media device is determined based on an angle of arrival between the tag and a UWB positioning system associated with the wireless device.

15. The method of claim 14, wherein the UWB positioning system associated with the wireless device is implemented in a headphone worn by a user, and the angle of arrival indicates a user orientation is facing toward the media device.

16. The method of claim 14, wherein the UWB positioning system associated with the wireless device is implemented in the wireless device carried by a user, and the angle of arrival indicates a user orientation is facing toward the media device.

17. A system, comprising:
location-based tags associated with respective media devices in an environment; and
a media playback manager implemented by a wireless device and configured to:
detect an available Bluetooth Low Energy (BLE) audio broadcast from a media device;
determine a position of the wireless device relative to the media device based on a location of a location-based tag associated with the media device; and
receive the BLE audio broadcast at the wireless device based on the position of the wireless device relative to the location of the location-based tag that is associated with the media device.

18. The system of claim 17, wherein the media playback manager is configured to assign a weight for the BLE audio broadcast based on metadata associated with the BLE audio broadcast.

19. The system of claim 18, wherein the media playback manager is configured to determine a queue of multiple BLE broadcasts based on the weight for the BLE audio broadcast and an assigned weight for at least one additional BLE audio broadcast.

20. The system of claim 19, wherein one of the multiple BLE audio broadcasts is associated with an emergency event and is assigned priority in the queue.
